(19) United States
(12) Patent Application Publication
(10) Pub. No.: US 2019/0181904 A1
(43) Pub. Date: Jun. 13, 2019

(54) APPARATUS, SYSTEM, AND METHOD FOR SUPPORTING, PROTECTING, AND VIEWING AN ELECTRONIC DEVICE

(71) Applicant: Antonio STURNIOLO, San Diego, CA (US)

(72) Inventor: Antonio STURNIOLO, San Diego, CA (US)

(21) Appl. No.: 16/275,276

(22) Filed: Feb. 13, 2019

Related U.S. Application Data
(62) Division of application No. 14/821,781, filed on Aug. 9, 2015.
Application No. 14/821,781 is a continuation-in-part of application No. 13/661,032, filed on Oct. 25, 2012, now abandoned.
(60) Provisional application No. 61/552,314, filed on Oct. 27, 2011.

(51) Int. Cl. H04B 1/3888; A45C 13/26; G06F 1/16; A45C 11/00

(52) U.S. Cl. CPC H04B 1/3888; A45C 13/26; A45C 2011/003; A45C 11/00; G06F 2200/1633; G06F 1/1626

(57) ABSTRACT

An improved cover and protector for handheld electronics and more specifically to a more dexterous tablet cover which allows for easier handling and positioning for easier user interface, and protection elements to avoid scratches, breaks from incidental contact, and accidental drops. The apparatus includes a front cover and a removable handle affixed to the rear cover with lockable rotational adjustment and a common attachment fixture for independently supporting the electronic device.

### CROSS-REFERENCE TO RELATED APPLICATIONS

This application claims priority to currently pending U.S. patent application Ser. No. 14/821,781 filed Aug. 9, 2015 entitled Apparatus, System, and Method for Supporting, Protecting, and Viewing an Electronic Device, which claims priority to Ser. No. 13/661,032 filed Oct. 25, 2012 entitled Tablet and Electronic Media Cover Protector and Handling Apparatus, which claims priority to U.S. provisional patent application 61/552,314 filed Oct. 27, 2011 entitled Electronic Device Protection Apparatus, the contents of all are incorporated herein by reference in their entirety.

### BACKGROUND OF THE INVENTION

### Technical Field

The invention relates generally to an improved cover and protector for handheld electronics, and more specifically to a more dexterous tablet cover which allows for easier handling and positioning for easier user interface.

### Background Art

People are constantly on the go with their busy schedules, and typically are accompanied with a variety of tools to organize and conduct their daily lives including hand-held computers, cellular “smart” phones, electronic tablets, IPads, and other mobile devices. Electronic tablets (also known as tablet computers or just “tablets”) were conceptualized in the mid-20th century and became popular in 2010. Tablets can come equipped with large display surfaces and/or touch screens, sensors, physical buttons, and ports.

Tablets are typically larger than smart phones or personal digital assistants at 7 inches (18 cm) or larger, measured diagonally. Some examples of tablets include the Apple iPad, HP TouchPad, Blackberry Playbook, Motorola Xoom, Barnes & Noble Nook, Toshiba Thrive, ASUS Eee Pad Transformer, Samsung Galaxy Tab 10.1, Amazon Kindle Fire, HTC Flyer, and other Android tablets. Some of these devices are large compared to the size of a person's hand, which requires dexterity to operate with both hands. Additionally, many of the latest devices currently available to consumers are expensive and easily susceptible to damage from scratching or dropping.

As such, the present disclosure provides for an apparatus to better hold, position, protect and use these tools by providing an improved cover which may protect these tools from scratching and damage, and facilitate an improved user interface while sitting down without access to a table, while walking, while running, or other activities difficult to perform while simultaneously handling an electronic device.

### BRIEF SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

A system for viewing a handheld electronic device is disclosed herein, where the handheld electronic device having a front side and a rear side, the front side including a display for viewing by a user. The system includes a rear cover, an attachment fixture coupled to the rear cover, a support stand, a manual release, a handle, and a handle couple including a handle lock. The rear cover is coupleable to the handheld electronic device, and configured to cover at least a portion of the rear side of the handheld electronic device. The support stand is configured to support the handheld electronic device in a viewing position, the support stand including a mounting bracket, the mounting bracket configured to couple with the attachment fixture, the support stand further including a support arm coupled to the mounting bracket. The manual release is configured to toollessly decouple the mounting bracket from the attachment fixture. The handle includes a hand attachment configured to wrap around the back side of the user's hand. The handle couple is configured to rotatably couple the handle with the attachment fixture such that the handle can pivot about a rotation axis substantially perpendicular to the display when coupled with attachment fixture, the handle lock configured to toollessly decouple the handle from the attachment fixture. The handheld electronic device may be interchangeably coupled with the stand and the handle via coupling the attachment fixture to one of the mounting bracket and the handle lock, respectively.

According to one embodiment an apparatus for viewing a handheld electronic device is disclosed herein. The apparatus includes a rear cover, a handle, a handle couple, and a support stand. The rear cover is configured to couple to the handheld electronic device, and configured to cover at least a portion of the rear side of the handheld electronic device. The handle includes a hand attachment configured to wrap around the back side of the user's hand. The handle couple includes an attachment fixture and a handle lock, the handle couple configured to removably and rotatably couple the handle with the rear cover, such that the handle can pivot about a rotation axis substantially perpendicular to the display when coupled with the rear cover, the attachment fixture configured to removably attach to the rear cover, the handle lock configured to toollessly couple and decouple the handle with the attachment fixture. The support stand includes a mounting bracket, a support arm, and a manual release, the support stand configured to support the handheld electronic device in a viewing position, the mounting bracket configured to removably couple with the attachment fixture, the support arm configured to attach to the mounting bracket, the manual release configured to toollessly decouple the mounting bracket from the attachment fixture.

According to another embodiment, a method viewing a handheld electronic device is also disclosed herein. The method includes coupling an attachment fixture to a rear cover; coupling the rear cover to the handheld electronic device, the rear cover configured to cover at least a portion of the rear side of the handheld electronic device; coupling the attachment fixture to a mounting bracket of a support stand, the support stand configured to support the handheld electronic device in a viewing position via the mounting bracket and a support arm coupled to the mounting bracket; decoupling the attachment fixture from the mounting bracket with a manual release, the manual release configured to toollessly decouple the mounting bracket from the attachment fixture; coupling the attachment fixture to a handle having a hand attachment configured to wrap around the back side of the user's hand; pivoting the display of the handheld electronic device about a rotation axis, the rotation axis being substantially perpendicular to the display when the handle is coupled with attachment fixture; and decoupling the attachment fixture from the handle with a handle lock, the handle lock configured to toollessly decouple the handle from the attachment fixture.

### BRIEF DESCRIPTION OF THE SEVERAL VIEWS OF THE DRAWINGS

FIG. 1 is a back-perspective view of an exemplary embodiment of an electronic device covering apparatus

FIG. 2 is a front-perspective view of an electronic device shown covered with the electronic device covering apparatus of FIG. 1.

FIG. 3 illustrates one embodiment of an electronic device covering apparatus, and includes FIGS. 3A-3G, each letter showing a different view of the embodied apparatus.

FIG. 4 illustrates one embodiment of an electronic device covering apparatus, and includes FIGS. 4A and 4B, each letter highlighting a different aspect of the embodied apparatus.

FIG. 5 represents one embodiment of the handle device of FIG. 4.

FIG. 6 represents one embodiment of the electronic device covering apparatus, where the integration of the hard and soft materials is shown.

FIG. 7 is an exploded, front-perspective view of an exemplary embodiment of an electronic device covering apparatus, with an exemplary front cover separated.

FIG. 8A is an exploded, front-perspective view of another exemplary embodiment of the electronic device protector, with a front cover removed.

FIG. 8B is an exploded, rear-perspective view of the electronic device protector of FIG. 8A, with an exemplary front cover included.

FIG. 8C is a detail rear-perspective view of an exemplary handle as shown in FIG. 8A as installed with an exemplary rear cover.

FIG. 8D is a detail front-perspective view of the handle of FIG. 8A, as assembled into an exemplary rear cover, illustrating one embodiment of its coupling mechanism to an exemplary rear cover.

FIG. 8E is a detail rear-perspective view of an exemplary handle as shown in FIG. 8A as removed from the exemplary rear cover.

FIG. 9A is an exploded partial rear-perspective view of yet another exemplary embodiment handle coupling mechanism to an electronic device protector.

FIG. 9B is a rear view of FIG. 9A and a cross-section view thereof.

FIG. 9C is a detail side-view of FIG. 9B.

FIG. 10A is a back-perspective view of an exemplary embodiment of an electronic device covering apparatus.

FIG. 10B is a back-perspective, exploded view of the apparatus of FIG. 10A.

FIGS. 10C and 10D illustrate the apparatus of FIG. 10A, kept at different angles and orientations.

FIG. 11A is a front-perspective, exploded view of the apparatus for protecting an electronic device, according to another embodiment.

FIG. 11B illustrates the apparatus of FIG. 11A configured for a support stand having a base.

FIG. 11C illustrates an apparatus similar to FIG. 11A engaged to a similar support stand.

FIG. 11D illustrates the apparatus of FIG. 11A, configured for a support stand having a support arm mount.

FIG. 11E illustrates the apparatus of FIG. 11A with the front cover attached, and shows how the front cover folds to support the electronic device on a surface with an inclination.

### DETAILED DESCRIPTION

The present disclosure generally relates to an improved cover and protector for handheld electronics, and more specifically to a more dexterous tablet cover which allows for easier handling and positioning for easier user interface, and protection elements to avoid scratches, breaks from incidental contact and accidental drops, and possible theft.

Materials contemplated for the cover portions include dual durometer plastics or a combination of plastics with more elastic materials including neoprene or other fabric materials or synthetic fabrics. For the more rigid back portion that integrates with the handle portion of an embodied cover a harder material is used with preference to a plastic, carbon fiber, or aluminum type hard portion, wherein the softer less rigid front surface cover may include a softer durometer plastic, silicone, neoprene or other synthetic or fabric material capable of covering and securing the front surfaces of an electronic device.

In the following detailed descriptions of various exemplary embodiments, reference is made to the accompanying drawings that form a part hereof, and in which is shown, by way of illustration, specific embodiments that may be practiced. It is to be understood that other embodiments may be utilized and structural changes may be made without departing from the scope of the present disclosure.

In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any devices, systems, and methods similar or equivalent to those described herein can be used in the practice or testing of embodiments of the present disclosure, the preferred, devices systems and methods are now described.

Generally, the present disclosure relates to versatile use electronic tablet covers, and provides a tool to better hold, position, protect and use these tools by providing an improved handle and positioning cover which may protect the surfaces of these electronic devices, and allow for an improved user interface. Features of embodied apparatuses may generally include a tablet cover in a tray style, with a handle. More particularly, the apparatus may include an electronic device interface, a rear cover, and a removable handle affixed to the rear cover with rotational capability. Additional features may include a locking rotation system to allow the user to hold the tablet in the palm of the hand which allows more mobility and ease of viewing. An additional embodiment may include a strap to secure the handle, which allows the user to utilize the tablet system in a secure way, while the other hand is free, or even provide some increased use of the hand holding the tablet.

As described further below, additional embodiments may include a combination or blend of hard and soft plastic, synthetic or fabric material, fused together with a harder or more rigid part on the bottom surface of the electronic device, wherein a hard portion can interface and stabilize and support the embodied handle attachment. An additional embodiment relies on a softer material which integrates with the harder material, and the softer material covers and helps protect the corners and portions of the viewing face of the electronic device, additionally the softer front portion may offer reinforced stabilization and better resistance.

In one aspect of various exemplary embodiments, an apparatus for handling and protecting an electronic device is provided, the apparatus including an electronic device interface adapted for viewing a display screen of the electronic device, with the electronic device interface constructed of at least a first material with soft durometer, a rear cover constructed of a material with hard durometer, a handle rotatably coupled to the rear cover, fastening means to join the rear cover to the electronic device interface, with the electronic device contained therebetween such that, when assembled, the position of the electronic device is fixed relative thereto, and an overall shape being formed similar to the electronic device to be protected.

In one aspect of various exemplary embodiments, an apparatus for handling and protecting an electronic device is provided, the apparatus including an electronic device interface and a rear cover formed to a shape similar to the electronic device when assembled therewith, the electronic device interface permitting a user to view a display screen of the electronic device, a handle with an adjustable strap, the rear cover having a connection permitting rotatable attachment of the handle thereto, and fastening means joining the electronic device interface to the rear cover with the electronic device contained therebetween.

In one aspect of various exemplary embodiments, an apparatus for handling and protecting an electronic device is provided, the apparatus including means for protecting a front of the electronic device, means for protecting a rear of the electronic device, means for securing the rear protecting means to the electronic device, means for handling the electronic device, means for rotatably coupling the handling means to the rear protecting means, means for fastening the front protecting means to the rear protecting means with the electronic device contained therebetween, and means for restricting movement of the electronic device relative to the protecting means. Examples of said means are located throughout the present disclosure, and their equivalents.

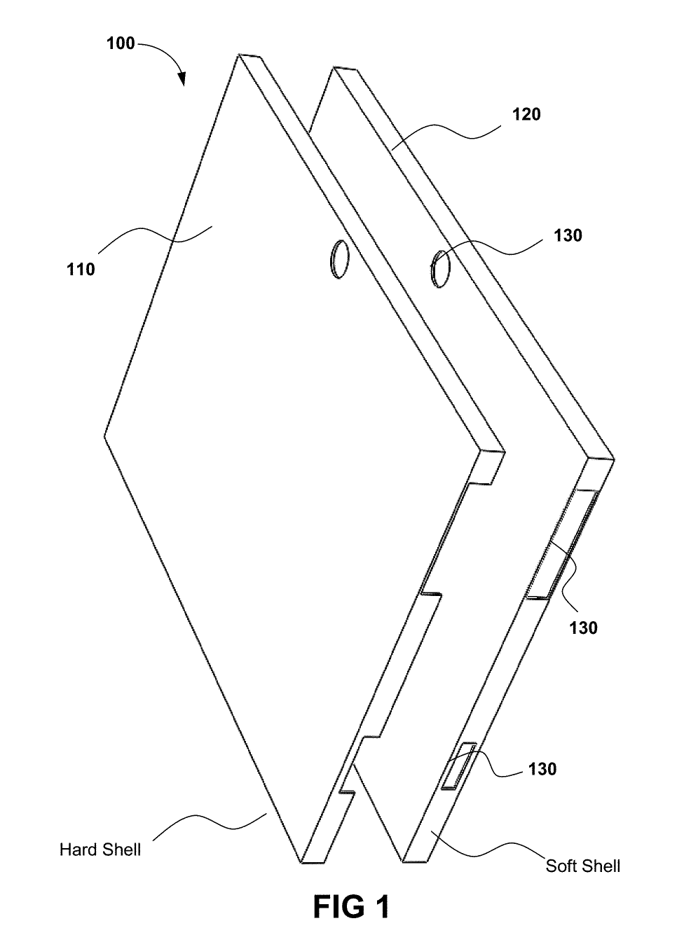

The following figures and examples are intended to illustrate but not limit the invention. FIGS. 1-23 feature embodied features in various views. The drawings described herein are for illustration purposes only and are not intended to limit the scope of the present disclosure in any way.

FIG. 1 is a perspective view of an exemplary embodiment of an electronic device covering apparatus. Here, the electronic device covering apparatus (“apparatus”) 100 is shown including a rear cover 110 and an electronic device interface (“EDI”) 120, each including various apertures 130 for interfacing with the tablet features (e.g., speaker, camera lenses, headphone jack, docking ports, microphones, various other ports). Accordingly, the EDI 120 is shown wrapped around the electronic device, exposing it at each aperture 130. As illustrated and as discussed below, the rear cover 110 may be made of a material having a hard durometer, and the EDI 120 may be made of a material having a soft durometer.

Aspects of the apparatus 100 may include a harder backside portion corresponding to rear cover 110, and a softer view-side portion corresponding to EDI 120. Here, the apparatus 100 is illustrated showing a hard shell portion in relation to a soft shell portion. For example, the rear cover 110 may be made of a first material while the EDI 120 may be made of a second material that is harder than the first material. Also for example, the rear cover 110 may be made of a material having hard durometer (discussed below), and the EDI 120 may be made of a material having soft durometer (also discussed below). Moreover, according to one embodiment, a handle (not shown) may be added or integrated to rear cover 110 (also discussed below).

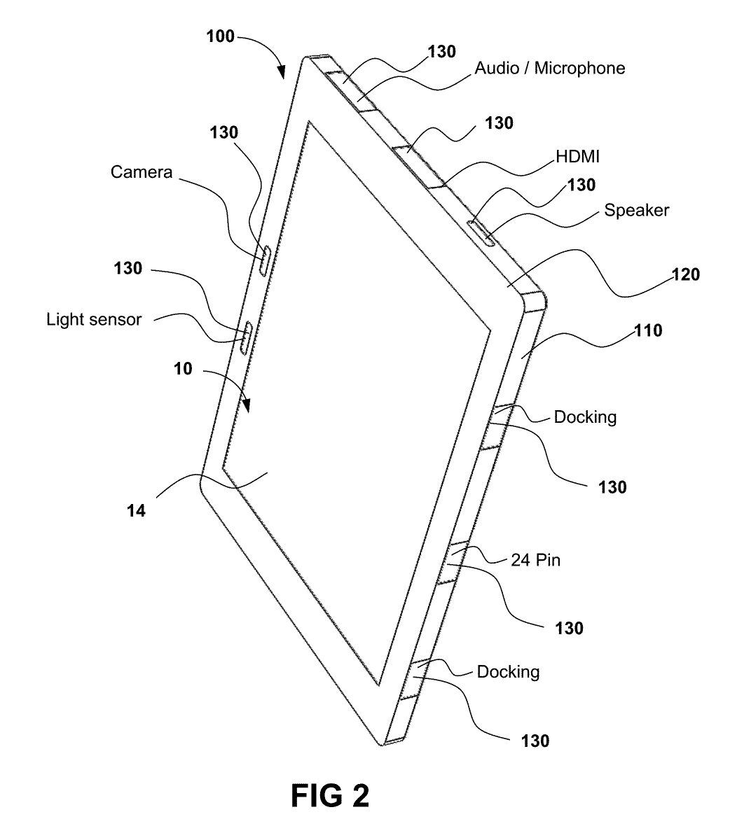

FIG. 2 is a front-perspective view of an electronic device shown covered with the apparatus of FIG. 1. Here, the apparatus 100 is shown installed, wherein it is used to cover and protect a tablet type computer or iPad. In particular, the EDI 120 is shown wrapped around the electronic device 10, exposing its display and each of its apertures 130. Likewise, the rear cover 110 is shown engaged with the EDI 120, exposing/providing access to the electronic device 10 at each aperture 130, and also exposing portions of the electronic device's front surface.

According to one embodiment the apparatus 100 may include an EDI 120 fastened to the electronic device 10 and configured to protect at least a portion of the front side of the electronic device while providing visibility of the display 14 to the user. The EDI 120 may be further configured to couple the rear cover 110 to the electronic device 10. Moreover, the EDI 120 may be at least partially made of a first material, the first material having a first durometer, while the rear cover 110 be at least partially made of a second material having a second durometer, with the second durometer being harder than the first durometer.

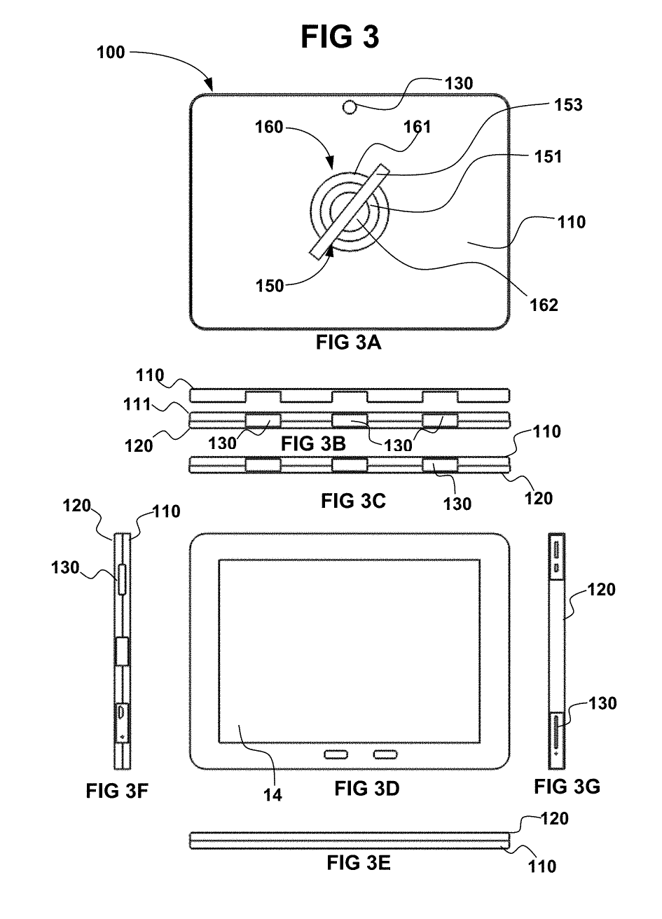

FIG. 3, including FIGS. 3A-3G, illustrates one embodiment of the apparatus 100, with the addition of a handle device integrated into the hard shell portion. Notably, the handle device is not shown in FIGS. 3B-3G for clarity.

FIG. 3A specifically shows the back side (commonly understood as the non-viewing surface) of an electronic device covered with an embodiment of the apparatus 100. Here, the visible features include a hard surface cover (rear cover 110), a handle 150, and a handle couple 160 or attachment apparatus. Additionally an aperture 130 in rear cover 110 is viewable, which is an aperture that allows the user to access operations associated with the electronic device, as discussed above.

The handle 150 may include a handle base 151 and a hand attachment 153 (e.g., a handle strap). The hand attachment 153 may be configured to wrap around the back side of the user's hand. According to one embodiment, the hand attachment 153 may be adjustable to secure the user's hand within the handle 150. For example, the hand attachment 153 may be configured to tighten around a plurality of hand sizes.

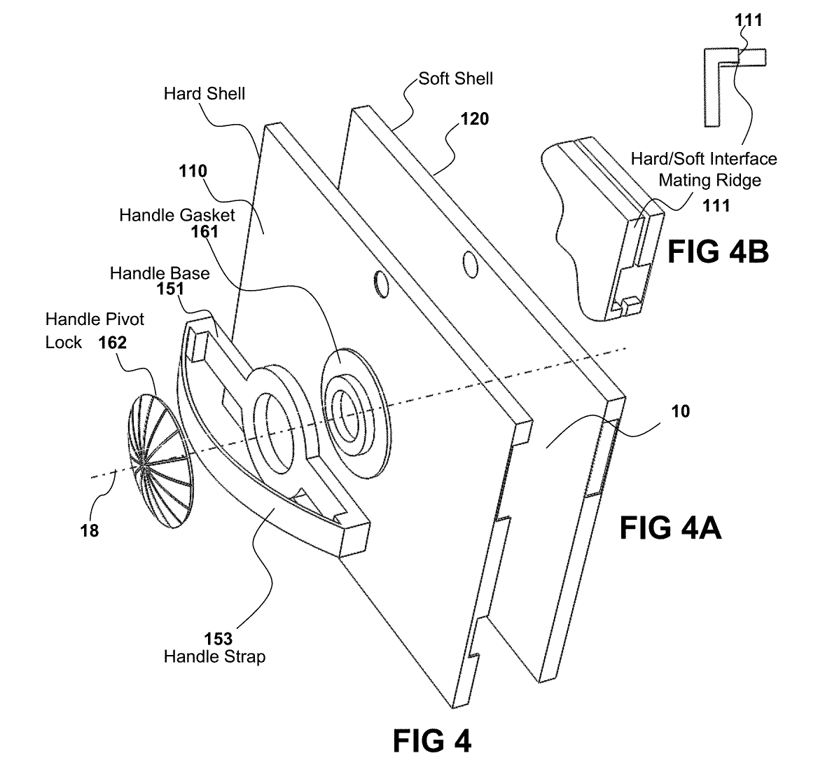

The handle couple 160 may include an attachment fixture 161 (e.g., a handle gasket) that attaches with or is otherwise fixed to rear cover 110) and a handle lock 162 (e.g., a handle pivot lock) which secures the handle base 151 to the attachment fixture 161. According to one embodiment, the handle lock 162 may pivotally or rotatably secure the handle base 151 to the attachment fixture 161 such that the handle can pivot about a rotation axis substantially perpendicular to the display when coupled with the support attachment interface. According to one embodiment the handle lock 162 may be configured to rotatably couple the handle 150 with the attachment fixture 161 such that the handle 150 can pivot about a rotation axis 18 (see FIG. 4) substantially perpendicular to the display when coupled with attachment fixture. Moreover, the handle lock 162 may be further configured to toollessly decouple the handle from the attachment fixture, as shown.

According to one embodiment, the handle couple 160 may be configured to secure the electronic device (e.g., a tablet) in place at a plurality of predetermined angles about the rotation axis 18 relative to the handle 150. In particular, one or more elements of the handle couple 160 may include locking features that lock the electronic device in place, which may be manually overcome, such that the user may reorient the viewing angle of the electronic device about the rotation axis 18. For example, the handle lock 162 may include click stops (see e.g., FIG. 12) which secure the tablet in place at given angle intervals. According to one embodiment, the handle couple 160 may secure the tablet in place at angle intervals ranging from 15 to 30 to 45 to 60 to 75 to 90 to 120 to 150 and to 180 degrees rotation. According to another embodiment, the handle couple 160 may be configured to secure the tablet in place at 30 degree angle intervals through 360 degrees. According to another embodiment, the handle couple 160 may be configured to secure the tablet in place at 8 to 12 predetermined angles distributed 360 degrees about the rotation axis 18. This may be beneficial as it allows the user to view the tablet display in a consistent orientation, despite the particular orientation in which it is held. Accordingly, the user may find greater agility in using the electronic device.

FIG. 3B specifically shows a side view just before the rear cover 110 is mated with the EDI 120 at an interface mating ridge 111, which, as illustrated may be a hard-soft interface mating ridge. Also, additional apertures 130 are viewable, as described above. Similarly, FIG. 3C shows a side view just after mating of the two covers occurs, covering the interface mating ridge 111.

FIG. 3D shows the portions the front side (commonly understood as viewing operational surface) of an electronic device covered with the apparatus 100. Here the EDI 120 is a soft cover that wraps around and covers the periphery of the electronic device's viewing screen (“display”) 14. Optionally, the EDI 120 may include a film or transparent covering that also covers the display 14.

FIGS. 3E through 3G show various end views of the apparatus 100, rear cover 110 and EDI 120, along with their apertures 130.

FIG. 4, including FIGS. 4A and 4B, is an exploded back-perspective view of another embodiment of the apparatus of FIG. 1, with the addition of a handle device that is attachable to the hard shell portion (back portion). For reference, rotation axis 18 may be generally defined as perpendicular to the display of the electronic device, with “forward” facing toward a viewing user.

Here, FIG. 4A shows the apparatus 100, further including an attached handle. As illustrated, the handle 150 may include an attachment fixture 161, a handle base 151 which interfaces with the attachment fixture 161 and a handle lock 162 (which secures the handle base 151 between the attachment fixture 161 and the handle lock 162). Also as illustrated, the handle 150 can pivot about the rotation axis 18.

The attachment fixture 161 may be secured to the rear cover 110 (here a hard cover). For example, the attachment fixture 161 may be secured by conventional attachment means on the back surface (exterior surface) of the rear cover 110. Also for example, the attachment fixture 161 may be secured to the rear cover 110 through a protrusion in the rear cover 110, to which a portion of the attachment fixture 161 extends.

The handle apparatus may also include a hand attachment 153 (e.g., a handle strap), which may be adjustable to secure the user's hand within the handle apparatus. FIG. 4B shows a blown-up view of the hard cover (rear cover 110)/soft cover (EDI 120) interface at the interface mating ridge 111.

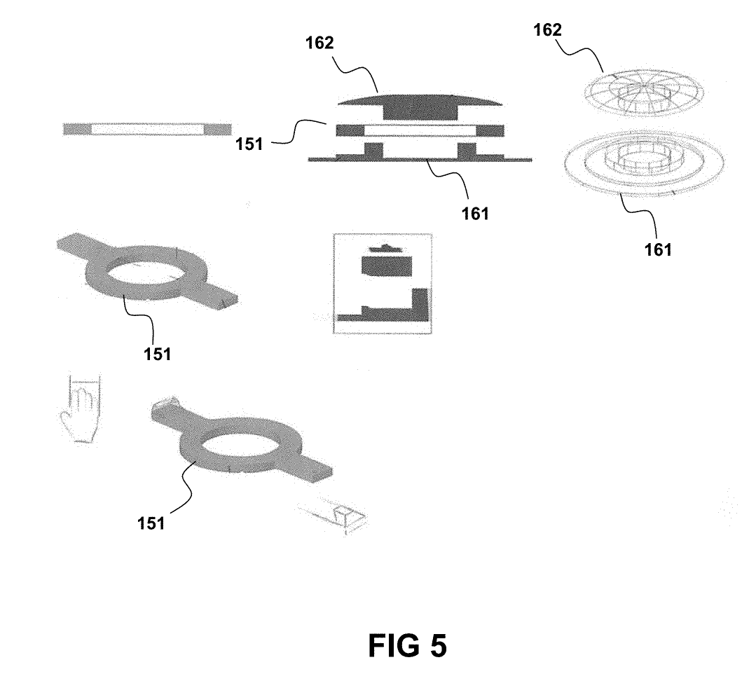

FIG. 5 represents one embodiment of the handle device of FIG. 4. Here, more aspects of an embodied handle apparatus contemplated in the present invention are shown, including the attachment fixture 161 and the handle base 151 locked down into place with the oversized handle lock 162. For example, the proportionality of the handle lock 162 to the attachment fixture 161 (as well as to the rear cover 110), provides the benefit of increased support against torsional loading inherent in larger size electronic devices such as tablets and hand computers.

As illustrated, the handle lock 162 fastens to the attachment fixture 161, with the handle base 151 riding therebetween. Here, the attachment fixture 161 is embodied as a round, bushing-type structure, the handle lock 162 may be embodied as a round dome, and the handle base 151 embodied as an annular structure with opposing arms extending outward, the annular structure sliding onto the bushing-type structure. Moreover, the handle lock 162 may be further configured to toollessly decouple the handle from the attachment fixture, as discussed below. For example the attachment fixture 161 and the handle lock 162 may threadably engage with each other.

In addition, the attachment fixture 161, the handle lock 162, and the handle base 151 are coaxial. In this way, the handle base 151 may rotate about the shared axis, allowing the user to rotate the electronic device. As discussed above, handle lock 162 may include interval stops which secure the tablet in place at given angle intervals.

According to one embodiment, the attachment fixture 161 and the handle lock 162 may also be sized based on the user's hand. In particular, the attachment fixture 161 and the lock 162 may have an outer diameter of approximately one half the user's hand width. For example, using an average hand width of about 85 mm (across 4 fingers), the attachment fixture 161 and the lock 162 may have a diameter of approximately 45 mm, or slightly greater that one half the hand width. While this embodiment of the handle device may require more materials, cost, and complexity than other attachments, the disclosed handle device may provide additional benefits. In particular, the disclosed attachment fixture 161 provides a much larger base that is inherently more capable to withstand torques induced by pressing the electronic device off-axis from its handle attachment point. This may be particularly beneficial in large screen devices such as tablets. In addition, by oversizing the lock 162, it may comfortably fit in the palm of the user's hand and provide for ease of removal. For example, with a conventional, screw-type attachment, the large size of the lock 162 provides for a larger palm gripping surface. This may be particularly advantageous, as it may provide for toolless installation and removal.

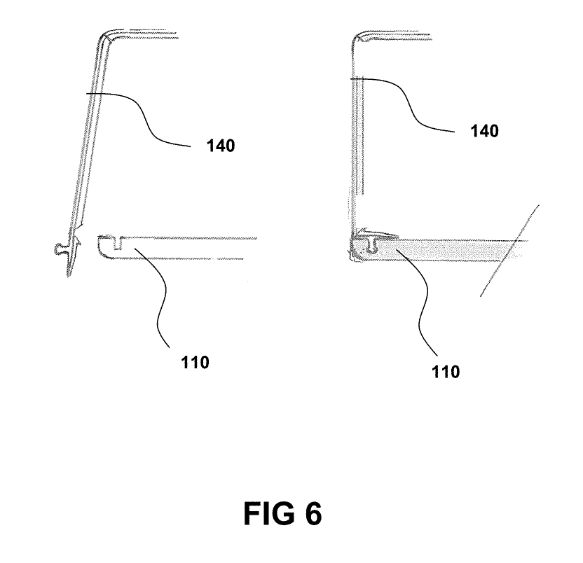

FIG. 6 represents another embodiment of the apparatus. Here, more aspects of apparatus 100 contemplated in the present invention are shown. In particular, apparatus 100 may include a front cover 140. Moreover, front cover 140 may be detachable as needed. For example, the removable front cover 140 may be secured using a toolless coupling, such as tongue and grooves, magnetic coupling, etc.

Additionally, the optional embodiment relates to the way the apparatus may be secured to an electronic device through tongue and grooves and sandwiching of the harder and softer cover materials. Here the integration of the hard and soft materials is shown, where a hard material (rear cover 110) is shown decoupled (left) and coupled (right) to a soft material (front cover 140). Alternately, the harder material may be the rear cover 110 and the softer material may be the EDI 120 using the tongue and grooves or interfacing at the interface mating ridge 111, as discussed above. Alternately, the harder material may be the electronic device and the softer material may be front cover 140. Moreover, in some embodiments, the soft material may be a combined structure of the EDI and front cover.

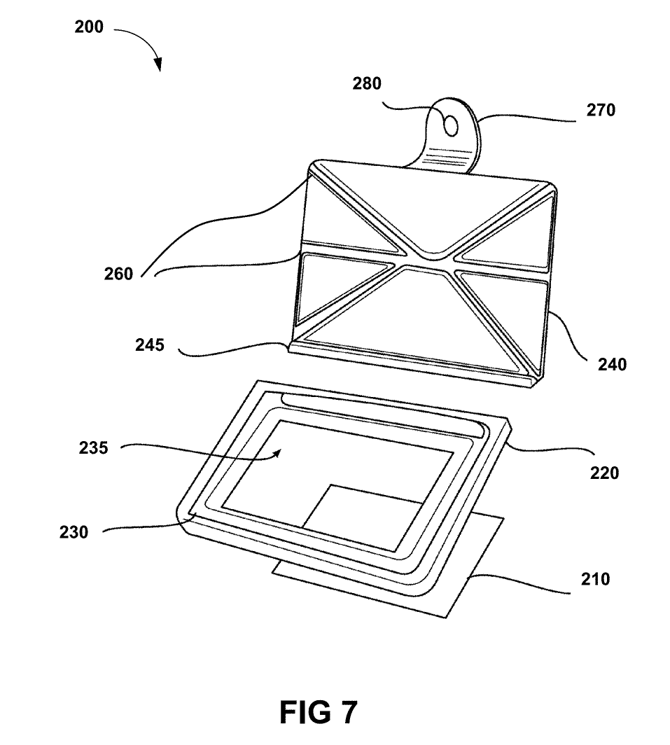

FIG. 7 illustrates an exemplary embodiment of the electronic device covering apparatus 200 in exploded view form, to more easily view the individual components. Here, the electronic device is removed for clarity. Apparatus 200 may include a rear cover 210, an electronic device interface (“EDI”) 220, and a front cover 240. As discussed below, in some embodiments, at least one of these elements may be removably or persistently combined with another. For example, according to one embodiment, the rear cover 210 may be incorporated as part of the EDI 220, thereby eliminating the rear cover 210 as a separate element.

As illustrated, the rear cover 210 may be configured to cover and protect a rear portion of the electronic device. Here, the rear cover 210 is shown as a harder backside portion of the apparatus 200. According to one embodiment, the EDI 220 may include a rear window 235 or opening exposing the electronic device, and the rear cover 210 may nest within the EDI 220, hence covering at least part of the rear window 235 and the otherwise exposed back portion of the electronic device.

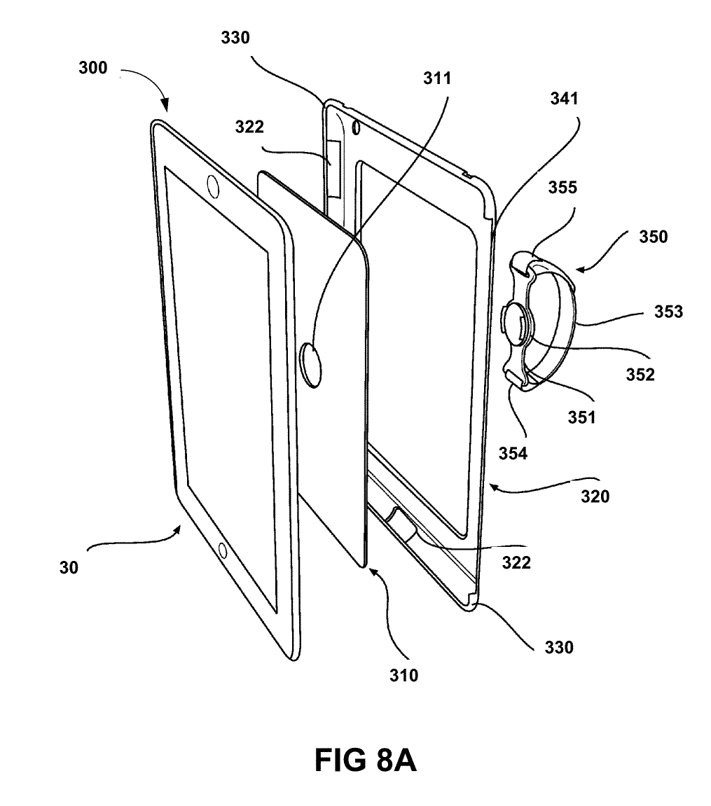

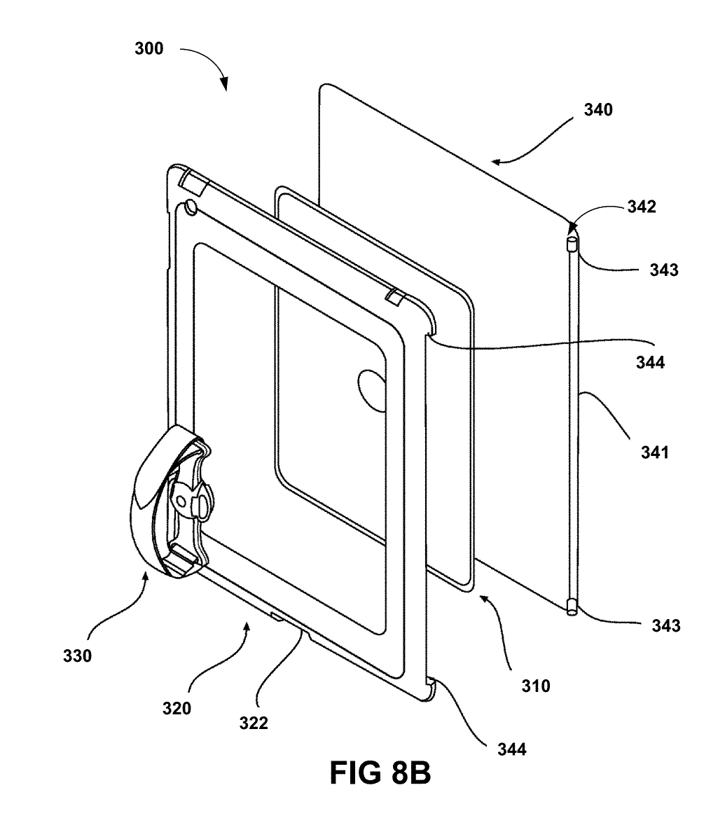

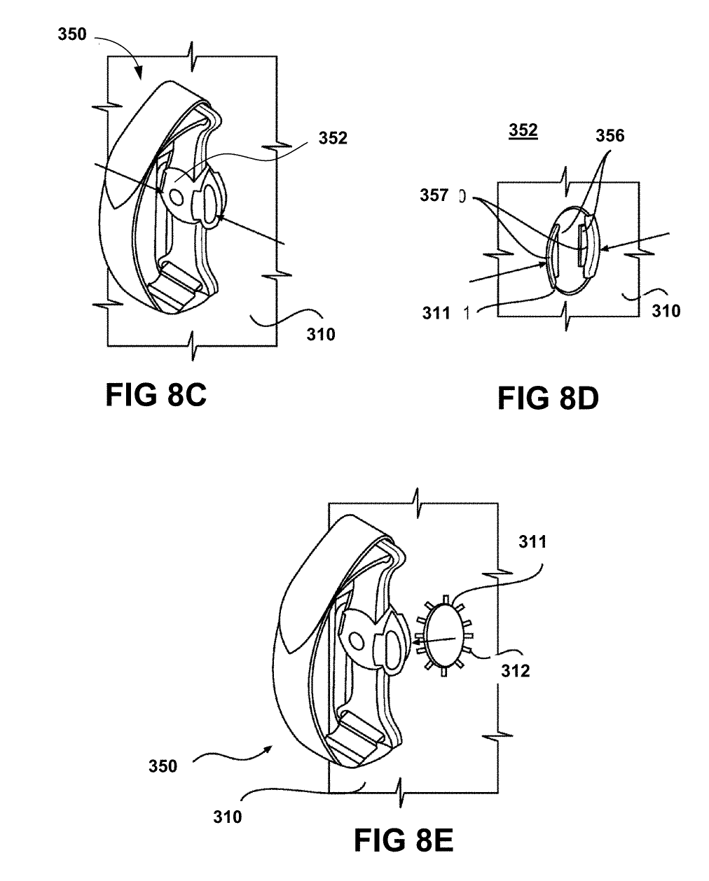

As discussed further below, the rear cover 210 may also function as a rigid support for a handle (see e.g., FIG. 8A). As illustrated, the EDI may be configured to engage four sides of the electronic device. According to one embodiment, the electronic device may be a tablet or similar device wherein the rear side of the electronic device has a surface area of at least 150 square centimeters or a diagonal length of at least 18 centimeters.

It is contemplated that a common rear cover 210 can be used while creating a variety of EDIs, each being conformed to fit different electronic device shapes. In particular, rear cover 210 may be designed as an interchangeable component for a variety of electronic devices, each having unique form factors, where the varying EDIs, such as EDI 220, each share a common rear window 235. This may provide many benefits such as simplicity of manufacture, reduced inventories, and lower cost.

The EDI 220 may be configured to cover, protect, and aid the user in better handling the electronic device. In particular, the EDI 220 may securely fasten to the electronic device, and provide a protective boundary. In addition, the electronic boundary interface may include an interfacing perimeter 230 that engages the electronic device on multiple sides. For example, the EDI 220 may conform to surfaces or features of the electronic device, such as its outside perimeter, rear plane, and front plane. It is understood that various electronic devices are contemplated, which may not conveniently be described in orthogonal terms. Accordingly, the EDI 220 may also conform to curves, lips, ledges, etc. as defined by the electronic device being interfaced with. According to one embodiment, the EDI 220 may be deformable or non-rigid. For example, EDI 220 may be constructed of at least one durometer of rubber, plastic, silicone, neoprene, or other synthetic compound that can be formulated with different durometers. A soft durometer may be between 30 Shore 00 and 50 Shore A, whereas a hard durometer may be between 51 Shore A and 75 Shore D.

According to one embodiment, the EDI 220 may be constructed of a plurality of materials and/or have variable structural properties. For example, the interfacing perimeter 230 of the EDI 220 may be constructed of a soft durometer material, whereas the back portion of the EDI 220 circumscribing the rear window 235 may be constructed of a hard durometer material, (e.g., forming a hard supporting lip). As such, the soft durometer material for the interfacing perimeter 230 of the EDI 220 may flex to allow insertion of the electronic device (not shown) into its front side of the EDI 220 (i.e., opposite the rear window 235). Likewise, the hard durometer material for the back portion of the EDI 220 may give greater structural support to the rear cover 210.

FIG. 7 also illustrates the apparatus 200 with a removable front cover 240. The front cover 240 may be attached to the EDI 220 or may be attached to the electronic device (not shown). Means with which to attach the front cover 240 may be a magnet 245, pins, hinges, toolless couplings, or other similar attachment means known to those skilled in the art. The front cover 240 may include a plurality of fold sections 260 about which a user may fold the front cover in order to adjust viewing the electronic device display (not shown) upon placing the apparatus 200 onto a surface.

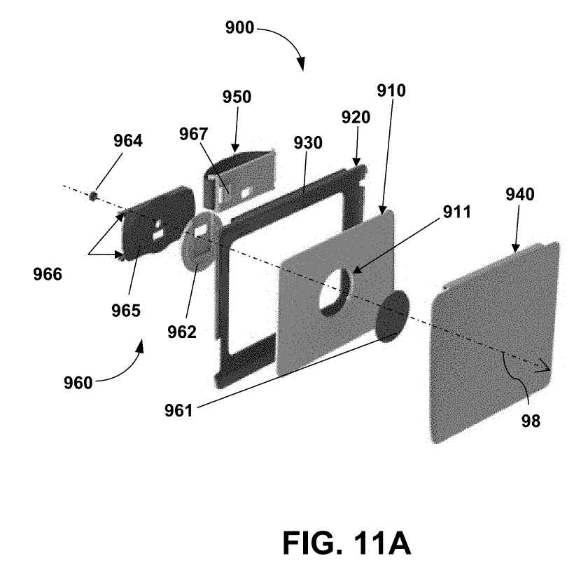

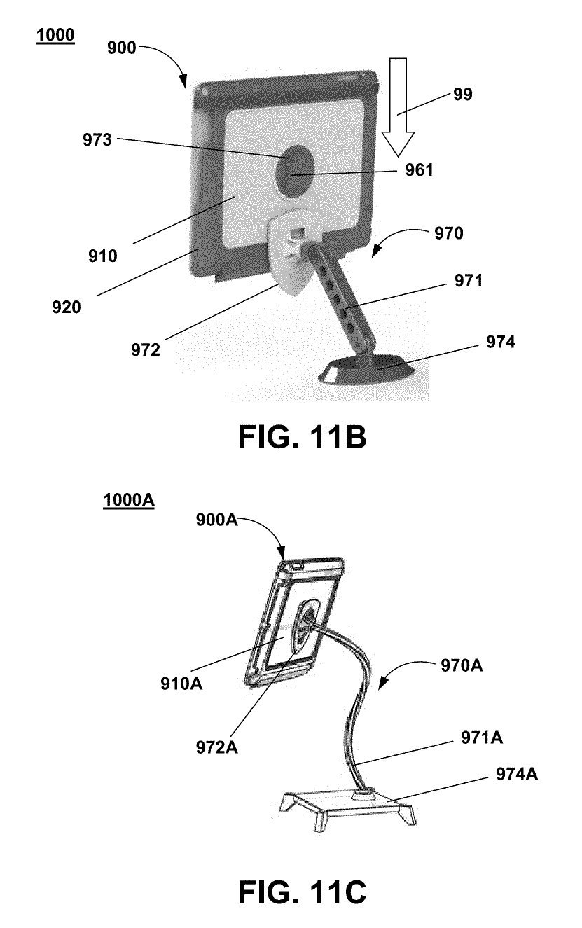

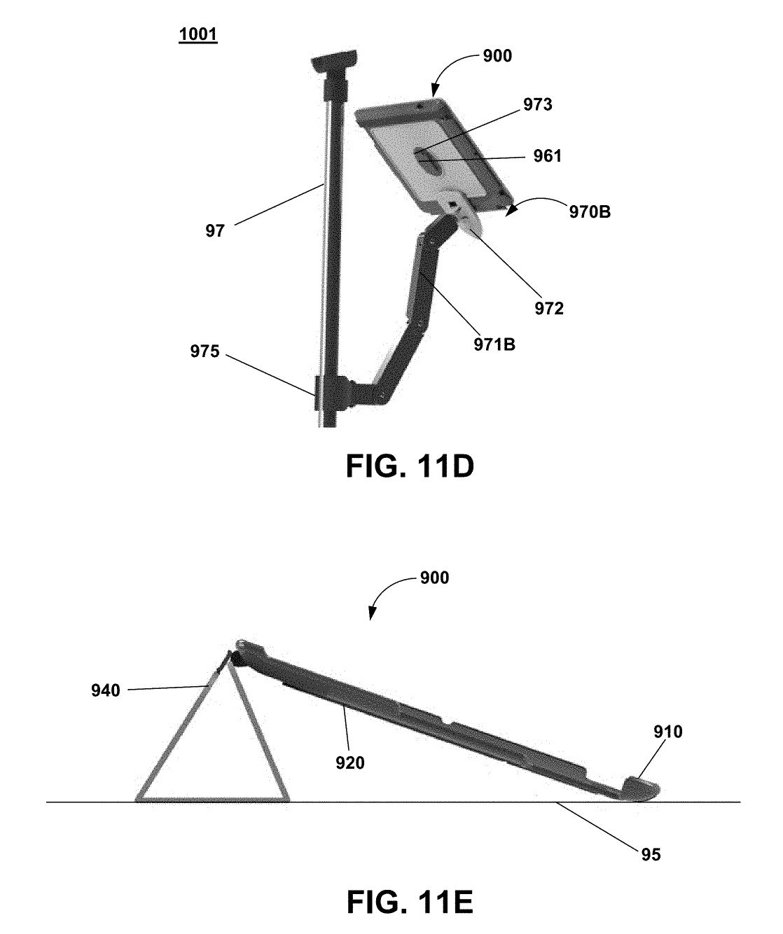

For example, when the front cover 240 is opened to expose a front display of the electronic device, it may be flipped behind and folded along one or more fold sections 260 forming a stand and such that the electronic device is viewable at one or more angles (see e.g., FIG. 11E). For example, as illustrated, the removable front cover 240 including the plurality of fold sections 260 may be configured to toollessly couple and decouple from at least one of the apparatus and the electronic device. Moreover, as illustrated, the removable front cover is reconfigurable as a stand for the electronic device via one or more of the plurality of fold sections.

Furthermore, the apparatus 200 may be configured to secure the front cover 240 in a closed position. For example, the apparatus 200 may include a flap 270 and snap 280 to close and secure the front cover 240 to the apparatus 200. As illustrated, the securing mechanism may be integrated into the front cover 240.

Turning now to FIGS. 8A and 8B, another embodiment of an apparatus 300 for protecting an electronic device 30 is shown. Apparatus 300 may include a rear cover 310 and an EDI 320. As above, the apparatus 300 may include a front cover 340 (which, for clarity, is removed in FIG. 8A). Likewise, the EDI 320 may conform to the electronic device 30 and may at least partially envelop the rear of the electronic device 30 (which, for clarity, is not shown in FIG. 8B).

In addition, as illustrated, the EDI 320 may be adapted for viewing the display screen. In particular, the EDI 320 may be configured to cover only a small fraction of the front face of the electronic device 30. For example, the surface area covered by the EDI 320 may be on the order of 5% of the total frontal surface area of the electronic device. To illustrate, where for example, the surface area of the front face of an 8 inch by 10 inch electronic device 30 may be 80 square inches, the surface area covered by the EDI 320 may be 3.56 square inches. The surface area of the aforementioned example may be computed by circumscribing a uniformly offset perimeter of approximately 0.1 inches on the face of the electronic device 30. It is understood that irregularities corresponding to apertures installation features may be included.

Alternatively, all or part of the EDI 320 may be transparent to allow full coverage of the viewing screen. For example, the EDI 320 may include a clear screen generally aligned with the display of the electronic device. It is, however, contemplated that full coverage of the electronic device viewing screen by the EDI 320 may not be advantageous for a touch-screen interface.

As with the exemplary embodiment shown in FIG. 7, the EDI 320 in FIG. 8A may include variable hardness. In particular, the EDI 320 may be constructed of one or more durometers of rubber, plastic, silicone, neoprene, or other synthetic compound that can be formulated with different durometers. For example, a softer, low durometer material may be employed in the interfacing perimeter 330 of the EDI 320 to conform to the shape of the electronic device 30 and to protect the edges of the electronic device 30 from damage. However, a rear portion of the EDI 320 may employ a harder, higher durometer material to support the rear cover 310.

As above, the rear cover 310 may nest within the EDI 320, where the rear cover 310 is contained between the EDI 320 and the electronic device 30 in order to restrict movement of the rear cover 310. Movement may be restricted through a friction fit, also known as a press fit or an interference fit. It is understood that a friction fit is used broadly and not limited to any particular surface or edges. For example, it may include a fastening between two parts which is achieved by friction after the parts are pushed together, rather than by any other means of fastening.

Additionally, EDI 320 may include one or more apertures 322. Here, a plurality of apertures 322 are viewable in the EDI 320. These apertures 322 allow the user to access operations associated with the electronic device 30, such as universal serial bus (USB) ports, power adapter ports, microphone jacks, camera lenses, or various other ports.

FIG. 8A also illustrates an apparatus 300, similar to apparatus 200, but with an exemplary handle 350, which may be rotatably secured or coupled directly to the rear cover 310, for example at handle interface 311. Here, handle interface 311 is represented as a round hole in the rear cover 310, however other shapes and configurations of handle couples are contemplated (e.g., including discrete attachment fixtures like handle gaskets, handle locks like click-stops, as described above).

Handle 350 may include a handle base 351, a handle pivot mechanism 352, and a handle strap 353. The handle 350 may be adjustable, further including a fixed strap end 354 and an adjustable strap end 355. The handle base 351 may employ at least one port through which the handle strap 353 may be passed, particularly for the adjustable strap end 355. The adjustable strap end 355 may be constructed with Velcro®, a watchband-type pin and hole combination, or other forms commonly known to those skilled in the art that yield length adjustment of the handle strap 353 to accommodate various hand sizes. For user comfort, the handle strap 353 may be constructed of fabric, rubber, or other soft, durable material known to those skilled in the art.

FIG. 8B is an exploded, rear-perspective view of apparatus 300, including an exemplary front cover 340. For clarity, the electronic device 30 of FIG. 8A is not shown here. In this embodiment, the front cover 340 may be constructed partially or entirely of a rigid plastic with hard durometer.

The front cover 340 may attach to the electronic device 30 or the apparatus 300. For example, the front cover 340 may couple to the electronic device 30 via a magnetic couple 341 (e.g., magnetic strip). Also for example, the front cover 340 may couple to the EDI 320 via a mechanical couple 342 (e.g., hinge mechanism with pins 343 and sockets 344) In addition, the attachment or coupling may be persistent or removable itself. It is understood that the exemplary attachment of the front cover 340 above may be alternately applied to the electronic device 30 or the apparatus 300, and that other persistent or removable couplings commonly known to those skilled in the art may be employed. Further still, the front cover 340 may be attached through a combination of magnetic couples 341 and mechanical couples 342.

According to one embodiment, the apparatus 300 includes a front cover for protecting the display of an electronic device. In one embodiment, the front cover 340 is constructed of rigid plastic. The front cover 340 may be adapted to be fitted to the EDI 320 via the mechanical couple 342, which may include a hinge mechanism including two pins 343 insertable inside sockets 344. Alternately, the front cover 340 may be adapted to be fitted to the rear cover 310, for example, though a hinge mechanism such as illustrated with pins 343 and sockets 344.

In one embodiment, the rear cover 310 includes a sheet and the handle interface 311 includes a hole in the sheet, for coupling the handle 350. In one embodiment, the front cover is constructed by rigid plastic.

Turning now to FIGS. 8C through 8E, a detail perspective view of an exemplary handle 350 and handle pivot mechanism 352 are shown. FIG. 8C illustrates a detailed view of the handle 350 fitted to the rear cover 310. The handle 350 includes a pivot mechanism 352 which is fitted to the hole (handle interface 311) to engage the handle 350 to the rear cover 310. The handle 350 is rotatable about a rotation axis passing through the center of the hole and substantially perpendicular to the rear cover 310.

The handle pivot mechanism 352 requires no tools to operate, and is thus toolless. The handle pivot mechanism 352 may be operated by a user manually applying force on at least one side of the handle pivot mechanism 352 in the direction of the opposing arrows. Referring to FIG. 8D, this applied force may disengage a locking mechanism, such as by elastically deforming tangs 356 to disengage semi-circular tabs 357 from the handle interface 311 in the rear cover 310. Alternatively, a compression spring (not shown) may be situated between the semi-circular tabs 357, or within the handle pivot mechanism 352, so that upon application of force, the compression spring (not shown) elastically deforms to allow the handle 350 to be disengaged from the rear cover 310 in the direction of the arrow as shown in FIG. 8E (along the rotation axis passing through the center of the hole and substantially perpendicular to the rear cover 310). It is these semi-circular tabs 357, at least in this embodiment, that provide for rotation of the handle 350 about the hole (handle interface 311).

In another embodiment, the handle 350 may be removed from circular hole (handle interface 311), and replaced by a mounting bracket (not shown). Such a mounting bracket (not shown) would be useful for affixing the apparatus 300 to a vehicle dashboard, a cup holder, a desk, or other frequently used locations where hands-free or single-hand operation is beneficial.

In one embodiment, handle interface 311 may include a rotational locking mechanism to facilitate in locking the handle 350 at angles ranging from 0 to 360 degrees, when the handle 350 is rotated. For example and as illustrated, the rear cover 310 may have click-stops 312 disposed about the perimeter of the hole (handle interface 311) at given angle intervals ranging from 15 to 30 to 45 to 60 to 75 to 90 to 105 to 120 to 135 to 150 to 165 and to 180 degrees.

The semi-circular tabs 356 may have mating protrusions (not shown) that engage the click-stops 312 and provide rotational locking. Unlocking can be accomplished either by applying a rotational force upon the handle of sufficient quantity to surmount the radial force exerted by the tangs 357 or spring (not shown), or depressing the semi-circular tabs 357 in the direction of the arrows shown in FIG. 8C or FIG. 8D, or by other means commonly known to those skilled in the art.

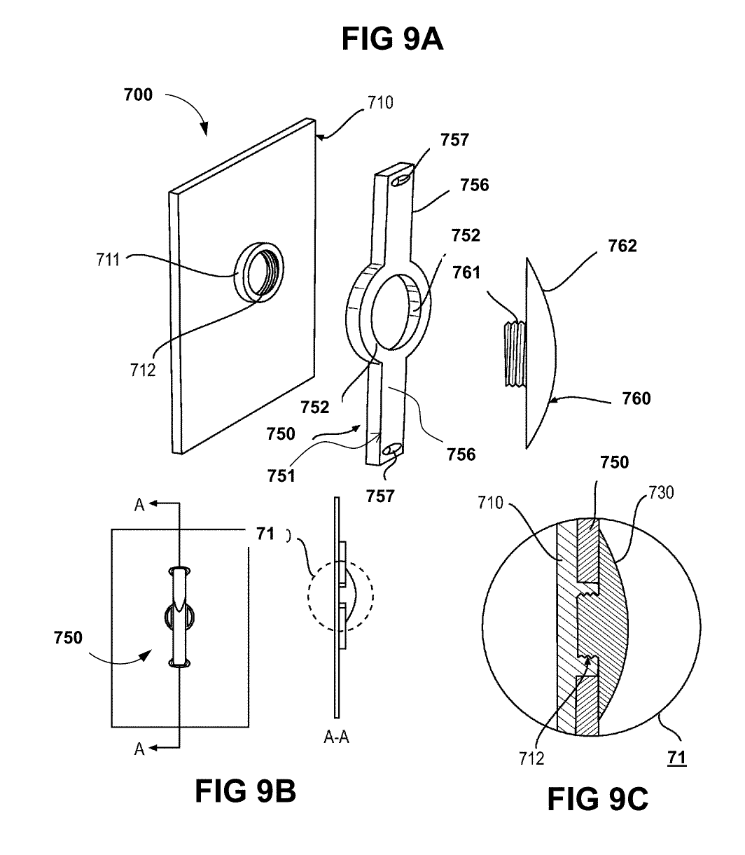

FIGS. 9A through 9C illustrate an exemplary embodiment of a handle coupling mechanism to an electronic device protector. In particular, FIG. 9A is an exploded partial rear-perspective view of a handle coupling mechanism to partially shown electronic device protector (“apparatus”) 700. FIG. 9B illustrates a rear view of FIG. 9A with cross-section view A-A thereof. Detail 71 is illustrated in FIG. 9C to illustrate a cross-section of the apparatus 700. The electronic device, front cover, handle strap, and removable front cover are not shown for clarity, but are similarly numbered to previous figures for ease of understanding.

According to one embodiment, the handle coupling mechanism may be configured for rotational coupling. For example, as illustrated here, the rear cover 710 may have a circular boss 711 protruding from the rear surface of the rear cover 710. The outer diameter of the circular boss 711 may then rotatably interface with handle 750 (partially shown). In particular, handle 750 may include a handle base 751 having a bearing ring 752, and further include opposing arms 756 that radially extend from the bearing ring 752. In this configuration, the circular boss 711 may rotatably interface with a bearing surface 753 of the bearing ring 752 to allow handle 750 to pivot or spin about the co-axis of the circular boss 711 and the bearing ring 752.

The handle 750 may be retained against the rear cover 710 by a handle lock 760. Retaining means may be an outside thread 761 on the handle lock 760 and inside thread 712 on the inside diameter of the circular boss 711. According to one embodiment, the handle 750 may be locked against free rotation by a friction fit between the handle 750 and the handle lock 760. In particular, a thrust force may be applied on the bearing ring 752 between the handle lock 760 and the circular boss 711. According to one embodiment, the rear of handle lock 760 may employ a partially hemispherical surface 762 to provide a comfortable fit with the palm of a user's hand.

According to one embodiment, the handle 750 may include a replaceable and/or adjustable strap. In particular, each opposing end of the handle base 751 may include a strap attachment. For example, at least one slot 757 may be disposed in at least one arm 756 at or near the distal end of the arm 756 for inserting at least one end of the handle strap (not shown).

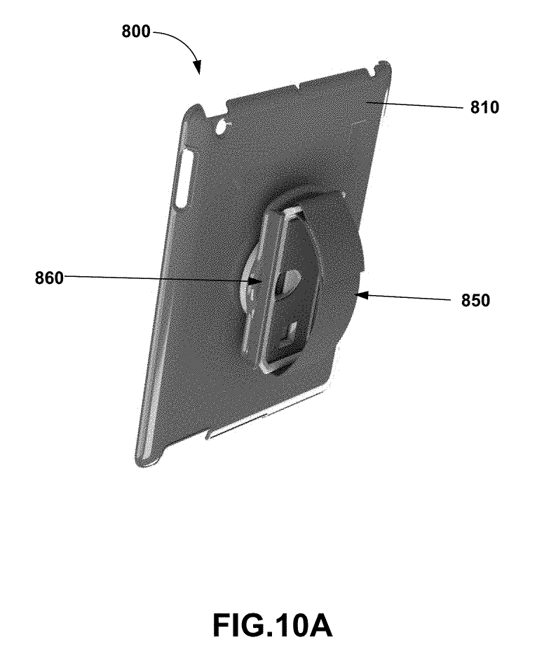

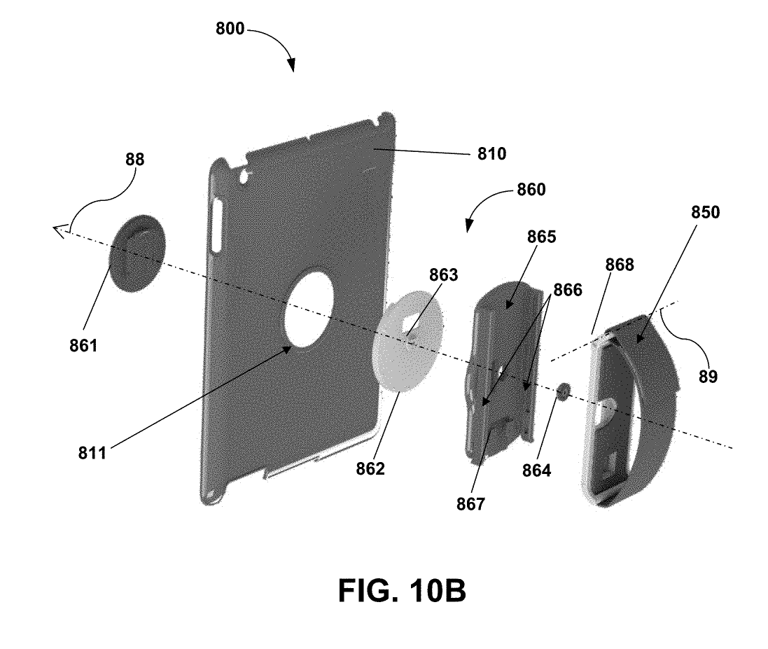

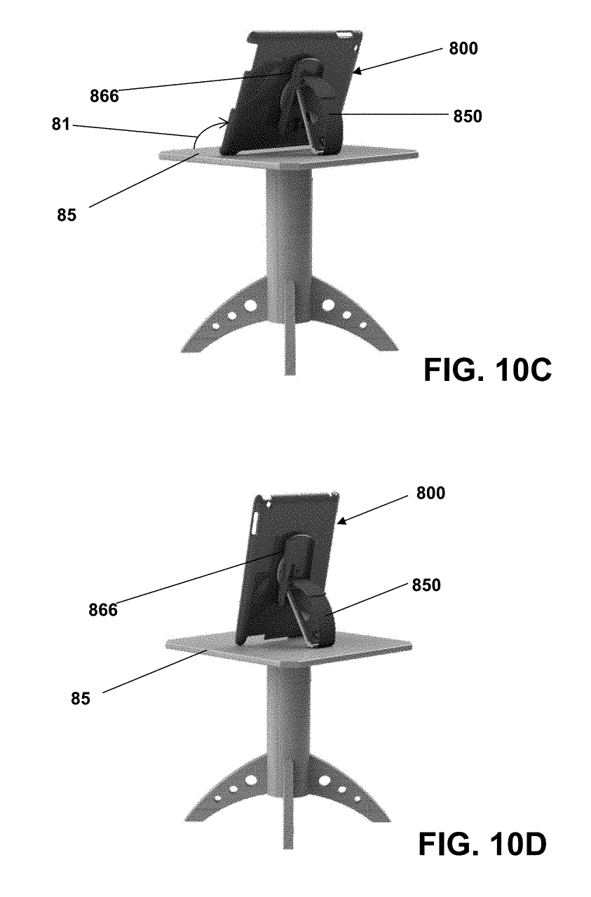

FIG. 10A is a back-perspective view of an exemplary embodiment of an electronic device covering apparatus (“apparatus”). The apparatus 800 includes a rear cover 810, and a handle 850. The handle 850 may be removably coupled to the rear cover 810. Moreover, handle 850 may be rotatably and/or slidably coupled to the rear cover 810. For example, handle 850 may be coupled to the rear cover 810 via a handle couple 860 configured to rotate and slide handle 850 relative to the rear cover 810. As discussed below, the handle couple 860 may be multi-functional.

FIG. 10B is a back-perspective, exploded view of an exemplary embodiment of the apparatus 800. For reference, rotation axis 88 may be generally defined as perpendicular to the display of the electronic device, with “forward” facing toward a viewing user.

As illustrated, apparatus 800 bears some similarity to the apparatus 100 in FIG. 1 in that rear cover 810 is configured to couple or interface with an electronic device (e.g., fitted about the periphery of the electronic device). Here, however, rear cover 810 includes an integration or combination of both the rear cover and the electronic device interface (“EDI”). In other embodiments the rear cover may be separable from an EDI (as in FIG. 1). Moreover. The separable components may be of the same material.

According to one embodiment, this integration (of a rear cover and EDI) may be simply accomplished as complex shape formed from a single material (e.g., hard shell, soft skin, intermediate material, etc.). Alternately and as illustrated, this integration may be embodied as a material or combination of materials formed as the rear cover 810, but having different properties at strategic locations (e.g., corresponding to the EDI). For example, rear cover 810 may be made of a softer material around the periphery of the electronic device (e.g., adaptable to engage and disengage from the electronic device) and harder material in the back portion of the electronic device (e.g., sufficiently strong/rigid to resist handle loads transferred to the apparatus 800). In this case, the materials may be discrete, coupled materials, blended materials, or some combination thereof.

Here, the rear cover 810 includes a handle couple interface 811. According to one embodiment, the handle couple interface 811 may be embodied as a hole or opening through a surface of the rear cover 810. Also, as illustrated, the hole may be round (i.e., about rotation axis 88), facilitating 360 degree rotation of the handle couple 860. As illustrated, the handle couple interface 811 may be generally centered on the rear cover 810 or may be offset. In addition, the handle couple interface 811 may include additional features, such as a lip or step in the rear cover 810 to better secure the handle couple, particularly during rotation. Moreover, the handle couple interface 811 may include limiting features against rotation such as dimples, notches, click-stops, and the like, as discussed further below.

As above the handle 850 may be coupled to the rear cover 810 via a handle couple 860. According to one embodiment, the handle couple 860 may include an attachment fixture 861 and handle lock 862. The attachment fixture 861 and the handle lock 862 may be coupled to each other and to the rear cover 810. For example, the rear cover 810 may be “sandwiched” between attachment fixture 861 and the handle lock 862 at the handle couple interface 811. Thus, to couple the handle 850, attachment fixture 861 may be set in or otherwise fixed to the handle couple interface 811, and the handle lock 862 may be coupled to the attachment fixture 861 from the outboard side of the rear cover 810. Moreover, one or both of the attachment fixture 861 and the handle lock 862 may be configured to correspond to and interface with additional features of the handle couple interface 811 described above (e.g., rotation limiting features).

According to one embodiment, the handle 850 may be rotatably coupled to the rear cover 810 via the handle couple 860. In particular, the attachment fixture 861 and the handle lock 862 may be further configured to provide rotation of the handle 850. For example, the attachment fixture 861 or the handle lock 862 may be configured to be fixed to the rear cover 810 while the other is at least partially free to rotate about rotation axis 88. Alternately, the attachment fixture 861 and the handle lock 862 may include a collar bearing interface or the like, such that both are axially fixed to the rear cover 810, while remaining at least partially free to rotate about rotation axis 88. Partial free rotation may refer to a limited range of motion or a rotational locking mechanism that sets predetermined limits to motion within a range, for example.

According to one embodiment, and as illustrated, both the attachment fixture 861 and the handle lock 862 may configured be fixed to the rear cover 810, and the handle lock 862 may be further configured include a collar bearing interface (e.g., boss 863 and cap 864) or the like, such that the handle 850 (and, optionally, any intermediate structures) are at least partially free to rotate about rotation axis 88 while the attachment fixture 861 and the handle lock 862 remain fixed to the rear cover 810.

According to one embodiment, the handle 850 may be reconfigurable as a handle stand, such that the display of the electronic device is propped up at an angle between 90 degrees and 180 degrees, relative to horizontal. In particular, the handle 850 may be pivotably coupled to the rear cover 810 via the handle couple 860 so as to deploy in a manner similar to a picture frame stand. For example, the handle couple 860 may be configured to provide for the handle 850 to pivot away from the rear cover 810 about a pivot axis 89, where the pivot axis 89 is normal to the rotation axis 88. To illustrate, FIG. 10C shows the apparatus 800 kept on a stand 85, such as a table with the handle 850 pivotably deployed outward or “fully deployed” from the handle couple 860 similar to a picture frame stand. Here, the handle couple 860 is oriented such that the display of the electronic device is in a viewable in a “landscape” orientation.

Returning to FIG. 10B, according to one embodiment, the handle 850 and/or the handle couple 860 may include a handle lock 867. The handle lock 867 may be configured lock the handle in a stowed position, and to prevent any pivotal motion until it is released. Moreover, handle lock 867 may positively lock the handle in place such that it does not inadvertently deploy. According to one embodiment, the handle lock 867 may be a toolless lock, which may be manually operated by the user. For example, the handle lock 867 may be embodied as a spring force loaded clip (e.g., deformable plastic molded in the “locked” position), detent or click stop lock, or friction/interference fit lock, to name a few.

In addition, the handle 850 and/or the handle couple 860 may include a pivot stop 868 configured to limit the angle that the handle 850 may swing out from the rear cover 810. For example, here, pivot stop 868 may be embodied as an angled end of the handle 850 extending from the rotation axis 88. In this way, the deployed handle 850 will be free to swing away from the rear cover 810 until the pivot stop 868 is contacted.

According to one embodiment, the handle 850 may be further reconfigurable as an adjustable handle stand. In particular, the handle 850 may be both pivotably and slidably coupled to the rear cover 810 via the handle couple 860, such that the display of the electronic device is in a viewable the a plurality of angles relative to its plane of rest. To illustrate, FIG. 10D shows the apparatus 800 kept on the stand 85 with the handle 850 pivotably deployed outward from the handle couple 860. Here however, the pivot axis of the handle 850 is slid down to a lower position than in FIG. 10C. Thus, the display of the electronic device may be more vertical (relative to resting surface of stand 85) than when in a higher position. Moreover, the handle 850 may be rotated about its rotation axis in conjunction to being deployed, thus providing further viewing flexibility. For example, here the electronic device is shown rotated 90 degrees about the rotation axis, such that the display of the electronic device is in a viewable in a “portrait” orientation. According to one embodiment, at least one of the handle 850 and the handle couple 860 may be further configured to secure the electronic device in place at the fully deployed view angle in both a portrait and a landscape orientation.

According to one embodiment, the handle couple 860 may further include a coupling element 865, having at least one rail 866 (here, two substantially parallel rails are used), which is attached to the handle lock 862. The handle 850 may include opposing guide pins that follow a tracks or grooves in each rail 866, such that the handle 850 is slidable along the length of the rails 866. It is understood alternate linear tracks may be used, such as a track/groove in a handle couple without rails. Moreover, said features may be inversely attributed to the handle 850 rather than the handle couple 860 (e.g., the handle 850 may include at least one rail or track). As above, additional features of the handle's attachment may include stops, locks, and the like, which are configured to limit the linear motion of the handle 850 to a predetermined range. Furthermore, the handle 850 and/or the handle couple 860 may include a toolless lock, such as handle lock 867 discussed above, which is further configured to prevent any linear motion until it is released, or the handle 850 is deployed (as embodied).

While these elements (and other elements throughout the present disclosure) are described as discrete items for clarity, it is understood that one or more may be combined, integrated into another structure, further divided, or any combination there, for convenience, ease of manufacture, etc., without departing from the spirit of the disclosure.

FIG. 10C and FIG. 10D illustrates the apparatus 800 kept on a stand 85, such as a table. Due to the slidable handle 850 along the length of the rails 866, the apparatus 800 can be kept on the stand 85 at various view angles 81 with respect to the horizontal plane. For reference, the apparatus may generally be viewed on the stand 85 between a 90 degree angle (vertical) and a 180 degree angle (flat on its back). Using this angular reference, according to one embodiment, the handle couple 860 may be configured to allow the handle 850 to pivot and rotate the display of the electronic device between the view angles 81 of 95 degrees and 175 degrees with respect to the horizontal plane. According to another embodiment, the handle couple 860 may be configured to allow the handle 850 to pivot and rotate the display of the electronic device between the view angles 81 of 92 degrees and 156 degrees with respect to the horizontal plane. According to one embodiment, the rails 866 may share an interference fit with the handle 850, such that the display may be set at any view angle 81 between its limits (here 92 degrees and 156 degrees).

According to another embodiment, the handle couple 860 may be configured to secure display in place at a plurality of predetermined view angles 81 with respect to the horizontal plane. In particular, one or more elements of the handle couple 860 may include locking features that lock the electronic device in place, which may be manually overcome, such that the user may vary and set the view angle of the electronic device. For example, the rails 866 may include detents, click stops, and the like which secure the tablet in place at given angle intervals.

According to one embodiment, the handle couple 860 may secure the tablet in place in at least one preset between its limits. In particular, the handle couple 860 may be further configured to secure the electronic device in place in at least one preset intermediate view angle between its fully deployed view angle (upper limit) and a closed position or a first view angle (lower limit). For example, the handle couple 860 may secure the tablet in place at any convenient view angles 81, such as 120 degrees and 150 degrees, in addition to its upper and lower limits. Examples of upper and lower limits may include 160 degrees and 95 degrees, or alternately, the beginning and ending angles of a swath covering at least 45 degrees between 90 degrees (vertical) and 180 degrees (horizontal facing upward). According to another embodiment, the handle couple 860 may secure the tablet in place at 120 degree, 135 degree, and 150 degree view angles between its upper and lower limits. According to another embodiment, the handle couple 860 may secure the tablet in place at multiple view angles, such as 92, 98, 101, 105, 107, 112, 113, 119, 124, and 156 degrees with respect to the horizontal plane. In accordance with the present subject matter, the handle 850 may be both rotatable around the rotation axis 88, and slidable perpendicular to the rotation axis 88.

FIG. 11A is a front-perspective, exploded view of the apparatus for protecting an electronic device, according to another embodiment. For reference, rotation axis 98 may be generally defined as perpendicular to the display of the electronic device, with “forward” facing toward a viewing user.

As illustrated, apparatus 900 bears some similarity to the apparatus 200 in FIG. 7 and the apparatus 300 in FIG. 8A in that it includes a rear cover 910 that is distinct and separable from its EDI 920. Moreover, rear cover 910 and its hardware may be reused across multiple tablets/devices wherein, just the EDI vary. As above, the EDI 920 may be made of a softer material around the periphery of the electronic device (e.g., adaptable to engage and disengage from the electronic device) and the rear cover 910 may be made of harder material (e.g., sufficiently strong/rigid to resist handle loads transferred to the apparatus 900).

Here, apparatus 900 includes EDI 920 and rear cover 910, with the rear cover 910 including a handle couple interface 911 (as described above). In one embodiment, the rear cover 910 and handle couple interface 911 may be embodied as a sheet having a hole. Here, the apparatus 900 further includes a handle 950 rotatably coupled to the rear cover 910 via a handle couple 960, with portions of the handle couple 960 fixedly coupled to the rear cover 910. In other embodiments, the handle couple 960, may be rotatably coupled to the rear cover 910.

As above, the handle couple 960 may include an attachment fixture 961 and handle lock 962. For coupling the handle 950, attachment fixture 961 is inserted to the hole (handle couple interface 911) from the inner side of the rear cover 910. The handle lock 962 is fitted to the attachment fixture 961 from the outer side of the rear cover 910. As above, the handle couple 960 may include a variety of attachment mechanisms, for example, the handle lock 962 may be further configured include a collar bearing interface (not shown) rotatably securing the handle 950 via cap 964 (or the like) as discussed above. Likewise, the handle couple 960 may include a variety of features corresponding to the handle couple interface 911 (e.g., rotation limiting features).

According to one embodiment, the handle 950 may be slidably coupled to the rear cover 910 via the handle couple 960. In particular, the handle couple 960 may be further configured to allow linear motion of the handle 950 perpendicular to the rotation axis 98 while the handle 950 remains otherwise fixed to the rear cover 910. For example, the handle couple 960 may further include a coupling element 965, having at least one rail 966 (here, two substantially parallel rails are used), which is attached to the handle lock 962.

Further, the handle 950 may be attached to the coupling element 965 via the at least one rail 966, such that the handle 950 is slidable along the length of the at least one rail 966. It is understood alternate linear tracks may be used, such as a groove in the handle couple 960. Moreover, said features may be inversely attributed to the handle 950 rather than the handle couple 960 (e.g., the handle 950 may include at least one rail). Additional features of the handle's attachment may include stops, locks, and the like, which are configured to limit the linear motion of the handle 950 to a predetermined range. Furthermore, the handle 950 and/or the handle couple 960 may include a toolless lock, such as handle couple lock 967 that is configured to prevent any linear motion until it is released.

Here, apparatus 900 further includes a front cover 940 attachable to the rear cover 910 such that an electronic device is sandwiched between the front cover 940 and the rear cover 910. A screen of the electronic device is made to face towards the front cover 940. The front cover 940 may be transparent for facilitating a user to view the screen of the electronic device. In some examples, width of an interfacing perimeter 930 of the rear cover 910 may be varied such that any size of electronic device can be accommodated by the apparatus 900.

FIG. 11B illustrates a system for supporting and viewing an electronic device. In particular, here the apparatus 900 configured to engage with both a handle (as described above) and a support stand (including a base), using a single attachment fixture. While apparatus 900 is used for illustration, it is understood that other embodiments of the electronic device covering apparatus may be used, such as in other figures. Here, as illustrated, the system 1000 may include a rear cover 910 coupled to the electronic device, and configured to cover at least a portion of the rear side of the electronic device, as described above. Likewise, an attachment fixture 961 may be coupled to the rear cover 910. The system 1000 may further include a support stand 970 configured to support the electronic device in a viewing position, with the support stand 970 including a mounting bracket 972. The mounting bracket 972 may be configured to couple with the attachment fixture 961. The support stand 970 may also include a support arm 971 coupled to the mounting bracket 972, providing for extension and maneuverability of the display. The support stand 970 may also include a manual release 973 configured to toollessly decouple the attachment fixture 961 from the mounting bracket 972. As shown, the manual release 973 may be embodied as part of the attachment fixture 961, such as a spring loaded clip. Alternately, the manual release 973 may be embodied as part of the mounting bracket 972. Also, the manual release 973 may be configured to lock the attachment fixture 961 with the mounting bracket 972.

According to one embodiment, the support stand 970 may further include a base 974 coupled to the support arm 971, where the base 974 is configured to support the electronic device via the support arm 971. In particular, the base 974 may be a grounded structure, having sufficient resistive force to support the electronic device, as well as additional forces associated with attaching the electronic device and adjusting it through a range of motions. For example, the base 974 may be mounted to a desk, table, or other fixed surface. Alternately, the base 974 may be embodied as a weighted structure, where its weight provides sufficient resistive support force.

Here, for ease of understanding, the apparatus 900 is shown disengaged from the support stand 970. The mounting bracket 972 may be slidably engaged to the attachment fixture 961 by moving it in the downward direction 99 when aligned. In particular, referring to FIG. 11C, the apparatus 900A is shown engaged with the support stand 970A. Here, system 1000A is shown as a similar variant to system 1000A in FIG. 11B. Here, however, the support arm 971A may be a deformable member having many degrees of freedom (in contrast to support arm 971 having restrictive motion). Likewise, here the base 974A may be configured to provide system support by distributing its load of the system 1000A rather than providing an independent ground.

FIG. 11D illustrates the apparatus of FIG. 11A, configured for a support stand having a support arm mount. In this particular embodiment of the system, the apparatus is configured to be mounted on a rod 97 (e.g., microphone stand).

Here, as illustrated, the system 1001 may include the system 1001 may include the apparatus 900 having the attachment fixture 961. The system 1001 may further include a support stand 970B configured to support the electronic device in a viewing position, with the support stand 970B including the mounting bracket 972 configured to couple and decouple with the attachment fixture 961, as discussed above. The system 1001 may further include the manual release 973 configured to toollessly decouple the attachment fixture from the mounting bracket, as above. The support stand 970 may also include a support arm 971B coupled to the mounting bracket 972, providing for extension and maneuverability of the display.

Here however, the support arm 971B is shown in yet another embodiment, including multiple linkages, and providing multiple degrees of freedom. For example, the support arm 971B may be adjusted to provide different angles and elevations of the apparatus 900.

In addition, the support stand 970B may further include a support arm mount 975 coupled to the support arm 971B. The support arm mount 975 may then be configured to parasitically mount to a supporting device. For example, here the support arm mount 975 may be embodied as a tube clamp, and the support arm 971B may be clamped to a tube, such as microphone stand 97. Application of the support arm 971B and the support arm mount 975 is not limited to the above explained application, and may be used anywhere to mount the apparatus 900. For example, the apparatus 900, in this embodiment (or variations thereof), may be advantageously clamped or otherwise affixed to a vehicle's dashboard, a cup holder, a desk, or at any other locations in the vehicle, just to name a few.

Moreover, the apparatus 900 (and other variants) may be decoupled from the support stand 970, and the various handles described above may be coupled using the common attachment fixture 961. In this way, the user may enjoy the benefit of holding the apparatus 900 by using the handle 950 (see e.g., FIG. 11A) and switching to a more stationary position or configuration.

FIG. 11E illustrates the apparatus including the front cover and shows how the front cover facilitates keeping the electronic device on a surface with an inclination. Here, according to one embodiment, the apparatus 900 may include the front cover 940. As above, the front cover 940 may be fixed or readily removable from either the apparatus 900 the apparatus 900 or the electronic device. The front cover 940 may be folded, rolled, or otherwise reconfigured to elevate or tilt an end of the electronic device, for example, using fold sections such as in FIG. 7. Moreover, the fold sections may fold into a plurality of shapes, such that different angles of support may be provided. Beneficially, the front cover 940 may facilitate to keep the electronic device on a surface 95 with an inclination for easier viewing. The apparatus described with reference to FIGS. 16 to 24, in some embodiments, may include a front cover such as shown in FIG. 7 as 240 or FIG. 24 as 940. According to one embodiment, the front cover may be transparent for facilitating a user to view the screen of the electronic device. According to another embodiment, the front cover may be made of leather embedded with stiffening panels divided by strategically placed fold sections.

Further embodiments may include security features such as loop for locking or securing the device to a surface, sensor device interfaces and apps which alert when a cover is removed without pin or password override, solar panel integration to enhance battery life, adaptable Bluetooth and wireless connections, security carrier with security cable and locks, and/or a track system with a moving dual handle. Yet further embodiments may include pocket options, clip devices to attach other materials and devices.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Thus, in the foregoing description, certain terms have been used for brevity, clearness, and understanding. No unnecessary limitations are to be implied there from beyond the requirement of the prior art because such terms are used for descriptive purposes and are intended to be broadly construed. Therefore, the disclosure is not limited to the specific details, the representative embodiments, and illustrative examples shown and described. Thus, this application is intended to embrace alterations, modifications, and variations that fall within the scope of the appended claims.

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

Although the invention has been described with reference to the above examples, it will be understood that modifications and variations are encompassed within the spirit and scope of the invention. Accordingly, the invention is limited only by the following claims.

What is claimed is:

1. A system for viewing a handheld electronic device, the handheld electronic device having a front side and a rear side, the front side including a display for viewing by a user, the system comprising:
a rear cover coupleable to the handheld electronic device, and configured to cover at least a portion of the rear side of the handheld electronic device;
an attachment fixture coupled to the rear cover;
a support stand configured to support the handheld electronic device in a viewing position, the support stand including a mounting bracket, the mounting bracket configured to couple with the attachment fixture, the support stand further including a support arm coupled to the mounting bracket;
a manual release configured to toollessly decouple the mounting bracket from the attachment fixture;
a handle including a hand attachment configured to wrap around the back side of the user's hand; and,
a handle couple including a handle lock, the handle couple configured to rotatably couple the handle with the attachment fixture such that the handle can pivot about a rotation axis substantially perpendicular to the display when coupled with attachment fixture, the handle lock configured to toollessly decouple the handle from the attachment fixture; and
wherein the handheld electronic device may be interchangeably coupled with the stand and the handle via coupling the attachment fixture to one of the mounting bracket and the handle lock, respectively.

2. The system of claim 1, further comprising an electronic device interface adaptable to engage and disengage from the handheld electronic device and configured to protect at least a portion of the front side of the handheld electronic device while providing visibility of the display to the user, the electronic device interface further configured to couple the rear cover to the handheld electronic device, the electronic device interface manually coupleable and decoupleable with the rear cover, the electronic device interface including at least a first material, the first material having a first durometer; and
wherein the rear cover is made of a second material, said second material having a second durometer that is harder than the first durometer.

3. The system of claim 1, further comprising a removable front cover, the removable front cover including a plurality of fold sections, and configured to toollessly couple and decouple from the rear cover; and,
wherein the removable front cover is reconfigurable as a stand for the handheld electronic device via one or more of the plurality of fold sections.

4. The system of claim 1, wherein the handle couple is further configured to provide for the handle to pivot away from the rear cover about a pivot axis, the pivot axis being normal to the rotation axis; and
wherein the handle is reconfigurable as a handle stand, such that the display of the handheld electronic device can be propped up at a fully deployed view angle between 95 degrees and 175 degrees, relative to horizontal when the handle is pivoted away from the rear cover, and when the handheld electronic device is coupled with the handle.

5. The system of claim 4, wherein the handle couple is further configured to secure the handheld electronic device in place in at least one preset intermediate view angle between the fully deployed view angle and a closed position, when the handheld electronic device is coupled with the handle; and,
wherein at least one of the handle and the handle couple are further configured to secure the handheld electronic device in place between the fully deployed view angle and the closed position in both a portrait and a landscape orientation, when the handheld electronic device is coupled with the handle.

6. The system of claim 5, wherein the handle couple is further configured to secure the handheld electronic device in place at a plurality of predetermined angles about the rotation axis; and
wherein the hand attachment is adjustable, and is further configured to tighten around a plurality of hand sizes.

7. The system of claim 1, wherein the support stand further includes a base coupled to the support arm, and the base is configured to support the handheld electronic device via the support arm.

8. The system of claim 1, wherein the support stand further includes a support arm mount coupled to the support arm, and the support arm mount is configured to parasitically mount to a supporting device.

9. An apparatus for viewing a handheld electronic device, the handheld electronic device having a front side and a rear side, the front side including a display for viewing by a user, the system comprising:
a rear cover configured to couple to the handheld electronic device, and configured to cover at least a portion of the rear side of the handheld electronic device;
a handle including a hand attachment configured to wrap around the back side of the user's hand;
a handle couple including an attachment fixture and a handle lock, the handle couple configured to removably and rotatably couple the handle with the rear cover, such that the handle can pivot about a rotation axis substantially perpendicular to the display when coupled with the rear cover, the attachment fixture configured to removably attach to the rear cover, the handle lock configured to toollessly couple and decouple the handle with the attachment fixture;
a support stand including a mounting bracket, a support arm, and a manual release, the support stand configured to support the handheld electronic device in a viewing position, the mounting bracket configured to removably couple with the attachment fixture, the support arm configured to attach to the mounting bracket, the manual release configured to toollessly decouple the mounting bracket from the attachment fixture.

10. The apparatus of claim 9, further comprising an electronic device interface adaptable to engage and disengage from the handheld electronic device and configured to protect at least a portion of the front side of the handheld electronic device while providing visibility of the display to the user, the electronic device interface further configured to couple the rear cover to the handheld electronic device, the electronic device interface manually coupleable and decoupleable with the rear cover.

11. The apparatus of claim 10, wherein the electronic device interface includes a first material, the first material having a first durometer; and
wherein the rear cover includes a second material having a second durometer, the second durometer being harder than the first durometer.

12. The apparatus of claim 11, wherein the first durometer is between 30 Shore 00 and 50 Shore A; and,
wherein the second durometer is between 51 Shore A and 75 Shore D.

13. The apparatus of claim 11, wherein the electronic device interface is configured to engage four sides of the handheld electronic device about the rotation axis, and includes a rear window exposing at least some of the portion of the rear side of the handheld electronic device; and
wherein the rear cover is nested within the electronic device interface, covering at least part of the rear window.

14. The apparatus of claim 13, wherein the rear side of the handheld electronic device has a surface area of at least 150 square centimeters or a diagonal length of at least 18 centimeters.

15. The apparatus of claim 1, wherein the handle couple is further configured to provide for the handle to pivot away from the rear cover about a pivot axis, the pivot axis being normal to the rotation axis; and
wherein the handle is reconfigurable as a handle stand, such that the display of the handheld electronic device can be propped up at a fully deployed view angle between 95 degrees and 175 degrees, relative to horizontal when the handle is pivoted away from the rear cover, and when the handheld electronic device is coupled with the handle.

16. The apparatus of claim 9, further comprising a removable front cover, the removable front cover including a plurality of fold sections, and configured to toollessly couple and decouple from the rear cover; and,
wherein the removable front cover is reconfigurable as a stand for the handheld electronic device via one or more of the plurality of fold sections.

17. The apparatus of claim 16, wherein the plurality of fold sections reconfigurable into a plurality of stand arrangements for the handheld electronic device via folding one or more of the plurality of fold sections.

18. The apparatus of claim 16, wherein the removable front cover includes a magnetic couple adapted to toollessly couple and decouple the removable front cover from the rear cover.

19. The apparatus of claim 18, further comprising an electronic device interface adaptable to engage and disengage from the handheld electronic device and configured to protect at least a portion of the front side of the handheld electronic device while providing visibility of the display to the user, the electronic device interface further configured to couple the rear cover to the handheld electronic device, the electronic device interface manually coupleable and decoupleable with the rear cover;
wherein the electronic device interface includes a first material, the first material having a first durometer;
wherein the rear cover includes a second material having a second durometer, the second durometer being harder than the first durometer;
wherein the handle couple is further configured to provide for the handle to pivot away from the rear cover about a pivot axis, the pivot axis being normal to the rotation axis; and
wherein the handle is reconfigurable as a handle stand, such that the display of the handheld electronic device can be propped up at a fully deployed view angle between 95 degrees and 175 degrees, relative to horizontal when the handle is pivoted away from the rear cover, and when the handheld electronic device is coupled with the handle.

20. A method for viewing a handheld electronic device, the handheld electronic device having a front side and a rear side, the front side including a display for viewing by a user, the method comprising:
coupling an attachment fixture to a rear cover;
coupling the rear cover to the handheld electronic device, the rear cover configured to cover at least a portion of the rear side of the handheld electronic device;
coupling the attachment fixture to a mounting bracket of a support stand, the support stand configured to support the handheld electronic device in a viewing position via the mounting bracket and a support arm coupled to the mounting bracket;
decoupling the attachment fixture from the mounting bracket with a manual release, the manual release configured to toollessly decouple the mounting bracket from the attachment fixture;
coupling the attachment fixture to a handle having a hand attachment configured to wrap around the back side of the user's hand;
pivoting the display of the handheld electronic device about a rotation axis, the rotation axis being substantially perpendicular to the display when the handle is coupled with attachment fixture; and,
decoupling the attachment fixture from the handle with a handle lock, the handle lock configured to toollessly decouple the handle from the attachment fixture.
